(19) United States
(12) Patent Application Publication
(10) Pub. No.: US 2016/0006123 A1
(43) Pub. Date: Jan. 7, 2016

(54) CONFORMAL ELECTRONIC DEVICES

(71) Applicant: MC10, INC., Cambridge, MA (US)

(72) Inventors: Xia LI, Wakefield, MA (US); Mitul DALAL, South Grafton, MA (US); Gilbert Lee HUPPERT, Stoneham, MA (US); Sanjay GUPTA, Bedford, MA (US)

(73) Assignee: MC10, INC., Cambridge, MA (US)

(21) Appl. No.: 14/524,817

(22) Filed: Oct. 27, 2014

Related U.S. Application Data
(60) Provisional application No. 62/019,592, filed on Jul. 1, 2014.

(51) Int. Cl. H01Q 7/00; H01Q 21/00; H01Q 1/14

(52) U.S. Cl. CPC H01Q 7/00; H01Q 1/14; H01Q 21/00

(57) ABSTRACT

The present invention relates to a flexible antenna that can harvest energy for short-range wireless communication such as near-field communication. The flexible antenna comprises a plurality of metal loops arranged in a concentric manner and disposed on a flexible base substrate. In some embodiments the flexible antenna can be stretchable. In some embodiments, the flexible antenna can be conformal. A flexible device comprising a chip or an integrated circuit electrically connected to the antenna can be used to perform one or more desirable functions (including user authentication, mobile payments, and/or location tracking) The flexible device can adhere to a surface such as the skin of a user.

### CROSS-REFERENCE TO RELATED APPLICATION

This application claims benefit under 35 U.S.C. §119(e) of U.S. Provisional Application No. 62/019,592 filed Jul. 1, 2014, the contents of which are incorporated herein by reference in their entirety.

### TECHNICAL FIELD

The present invention relates generally to wearable and flexible electronic devices having flexible antennas. More specifically, some embodiments of the invention relate to flexible and/or stretchable electronic devices that can be worn on the body having stretchable and flexible the antennas, and applications including energy harvesting and short-range wireless communication, such as, radio frequency identification (RFID) and near-filed communication (NFC).

### BACKGROUND

The field of flexible and/or stretchable electronics continues to grow due to the demand of high performance and mechanically unconstrained applications of the future. On-board power sources have been a limiting factor in maximizing flexibility and/or stretchability.

### SUMMARY

Described herein are flexible and/or stretchable electronic devices that can function without an on-board power source. The invention is based, in part, on a flexible antenna that can harvest energy from a device via, for example, near-field communication. The energy harvested by the antenna can power a chip or an integrated circuit that is electrically connected to the antenna.

One aspect of the invention relates to a flexible antenna comprising: a base substrate; and a first plurality of metal loops arranged in a concentric manner and disposed on a first side of the base substrate. The metal loops are electrically connected, whereby electrical connectivity is maintained during flexing. And each metal loop comprises at least two arc segments, each arc segment having an arc center and a radius, wherein the radius of one arc segment is greater than the radius of at least one other arc segment.

In accordance with some embodiments of the invention, the arc centers alternate between being inside the metal loop and outside the metal loop.

In accordance with some embodiments of the invention, all the arc centers are inside the metal loop.

In accordance with some embodiments of the invention, all the arc centers are outside the metal loop.

In accordance with some embodiments of the invention, the antenna is substantially planar in a resting state.

In accordance with some embodiments of the invention, the arc centers inside the metal loop are arranged in a geometric pattern.

In accordance with some embodiments of the invention, the arc centers outside the metal loop are arranged in a geometric pattern.

In accordance with some embodiments of the invention, the geometric pattern is rectangular, circular, elliptical, oval, octagonal, hexagonal, or pentagonal.

In accordance with some embodiments of the invention, a portion of the base substrate inside the metal loops is removed, thereby permitting the antenna to be stretchable.

In accordance with some embodiments of the invention, the base substrate is physically separated into a plurality of singulated substrates, wherein at least one metal loop is disposed on each singulated substrate.

In accordance with some embodiments of the invention, the base substrate has a thickness of no more than 100 μm.

In accordance with some embodiments of the invention, each metal loop has a thickness of no more than 100 μm.

In accordance with some embodiments of the invention, each arc segment of the metal loop has a radius greater than the width of the substrate having the metal loop disposed thereon.

In accordance with some embodiments of the invention, the antenna can conform to a surface to which it is applied.

In accordance with some embodiments of the invention, the antenna permits short-range wireless communication.

In accordance with some embodiments of the invention, the short-range wireless communication is near field communication (NFC) or radio-frequency identification (RFID).

In accordance with some embodiments of the invention, each metal loop is comprised of a metal selected from the group consisting of copper, aluminum, gold, platinum, silver, silver paste, and paste with metallic nanoparticles.

In accordance with some embodiments of the invention, the base substrate is comprised of polyimide, polyethylene terephthalate, polyester, polyurethane, polycarbonate, or a combination thereof.

In accordance with some embodiments of the invention, the antenna further comprises a second plurality of metal loops arranged in a concentric manner and disposed on a second side of the base substrate, wherein the second plurality of metal loops are electrically connected to the first plurality of metal loops.

In accordance with some embodiments of the invention, the antenna further comprises an encapsulation layer and an adhesive layer, wherein the base substrate and the first plurality of metal loops are sandwiched between the encapsulation layer and the adhesive layer.

In accordance with some embodiments of the invention, the encapsulation layer and/or the adhesive layer is gas permeable.

In accordance with some embodiments of the invention, the antenna further comprises an encapsulation layer, wherein the encapsulation layer embeds the base substrate and the first plurality of metal loops, whereby flexing the encapsulation layer flexes the antenna.

In accordance with some embodiments of the invention, the antenna further comprises at least one mechanical stress weak point that can break when a certain mechanical stress threshold is reached.

In accordance with some embodiments of the invention, each metal loop comprises 5 arc segments having arc centers inside the metal loop, and 5 arc segments having arc centers outside the metal loop.

A related aspect of the invention relates to a flexible device for short-range wireless communication comprising the antenna described herein and a chip or an integrated circuit electrically connected to the antenna.

In accordance with some embodiments of the invention, the short-range wireless communication is near field communication (NFC).

In accordance with some embodiments of the invention, the flexible device is stretchable.

In accordance with some embodiments of the invention, the flexible device can conform to a surface to which it is applied.

### BRIEF DESCRIPTION OF THE DRAWINGS

FIG. 1 is a schematic showing the 3-layer cross section structure for an example electronic device platform.

FIG. 2 is a schematic of a flexible device with antenna in accordance with some embodiments of the invention, where the distance from one end of the coil to the other measures about 28.65 mm (as shown). The flexible printed circuit board (flex PCB) can be configured as a narrow ribbon following the flower shape. The center part of the example antenna can be left empty or can include one or more electronic components. In other examples, antennas of other dimensions and/or shapes are also applicable.

FIG. 3 a schematic of an example electronic device with antenna in accordance with some embodiments of the invention.

FIG. 4 is an example electronic device process block diagram.

FIG. 5 shows example die dimension, I/O pad locations for NXP NTAG™ 213 bare die.

FIG. 6 is a schematic of an example of the flexible and stretchable NFC radio-frequency identification (RFID) antenna design following the design methodologies and rules outlined in this invention.

FIG. 7 is an image of a prototype.

FIG. 8A is a schematic of an antenna design.

FIG. 8B is a schematic of cross section A-A.

FIG. 8C is a schematic of cross section B-B.

FIG. 9A is a schematic showing a top down view of a flexible antenna 100 in accordance with some embodiments of the invention.

FIG. 9B is a schematic showing a view from an opposite side of the same flexible antenna 100.

FIG. 9C is a schematic showing that a chip or integrated circuit is electrically connected to the flexible antenna.

FIG. 10 is a schematic showing the operation of a flexible device in accordance with some embodiments of the invention.

FIG. 11A is a schematic of a metal loop of an antenna design.

FIG. 11B is a schematic of a metal loop of an antenna design.

FIG. 12 is a schematic of a metal loop of an antenna design.

### DETAILED DESCRIPTION

Following below are more detailed descriptions of various concepts related to, and embodiments of, inventive methods, devices, and systems for quantitative analysis using flexible electronic devices that include no power source or a low-power source, as non-limiting examples, for such applications as user authentication, mobile payments, and/or location tracking It should be appreciated that various concepts introduced above and discussed in greater detail below can be implemented in any of numerous ways, as the disclosed concepts are not limited to any particular manner of implementation. Examples of specific implementations and applications are provided primarily for illustrative purposes.

### Flexible Antenna and Devices Comprising the Antenna

Described herein are flexible antennas useful for near-filed wireless communication. The invention exploits the phenomenon that electrically-connected metal loops can generate an electrical current in response to a magnetic field. The electrical current in turn can power a chip or an integrated circuit. A standard electrical calculation and/or simulation known in the art can be performed to determine the number of metal loops and the size for a functional NFC/RFID antenna.

One aspect of the invention relates to a flexible antenna comprising: a base substrate; and a first plurality of metal loops arranged in a concentric manner and disposed on a first side of the base substrate. The metal loops are electrically connected, whereby electrical connectivity is maintained during flexing. And each metal loop comprises at least two arc segments (e.g., 2, 3, 4, 5, 6, 7, 8, 9, 10, or more), each arc segment having an arc center and a radius, wherein the radius of one arc segment is greater than the radius of at least one other arc segment.

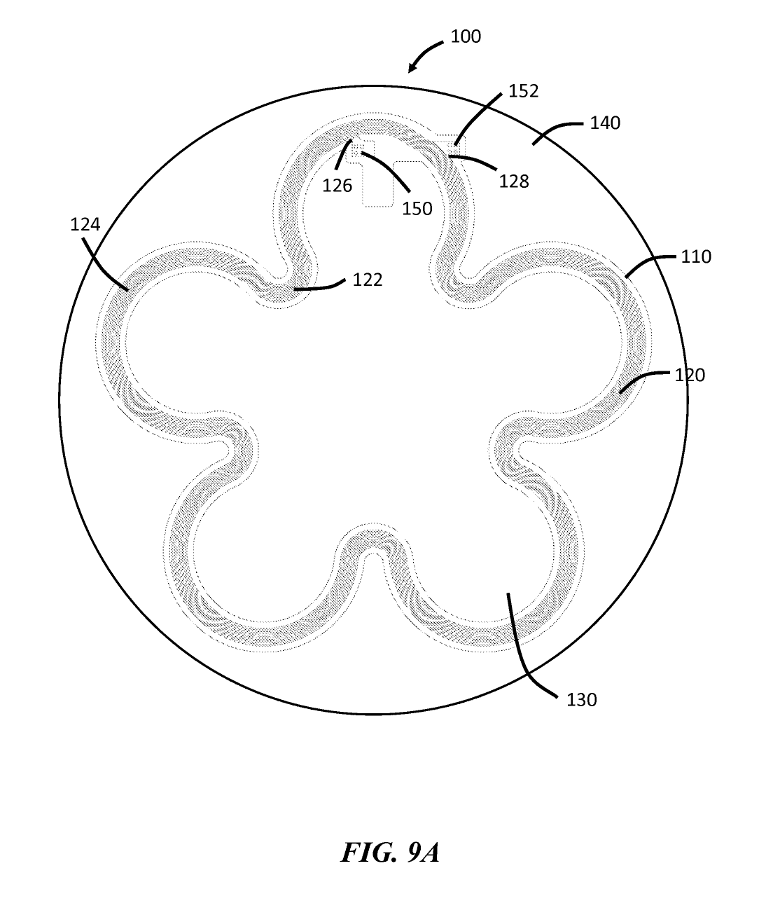

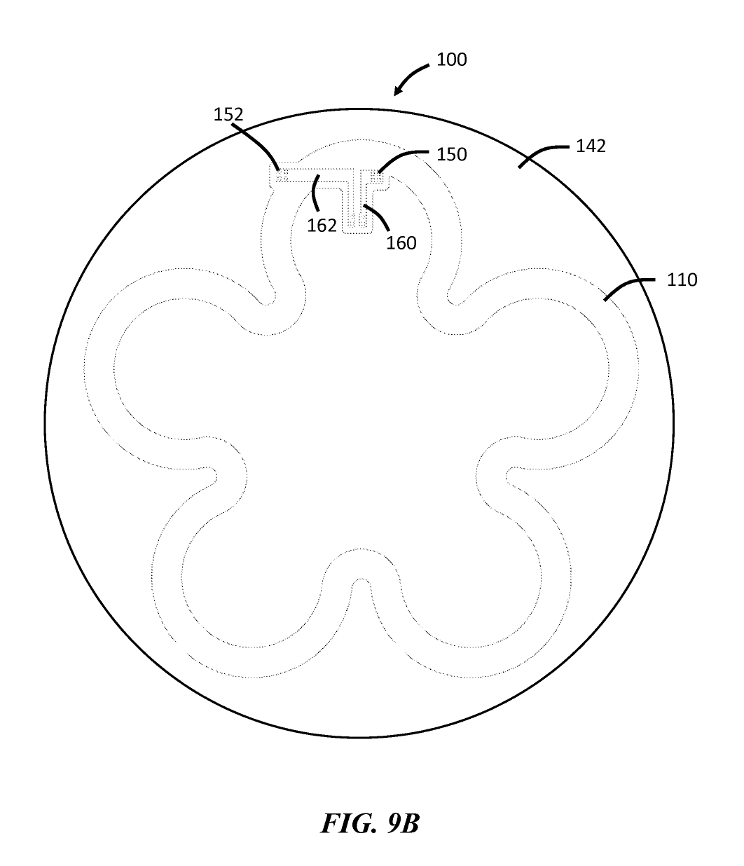

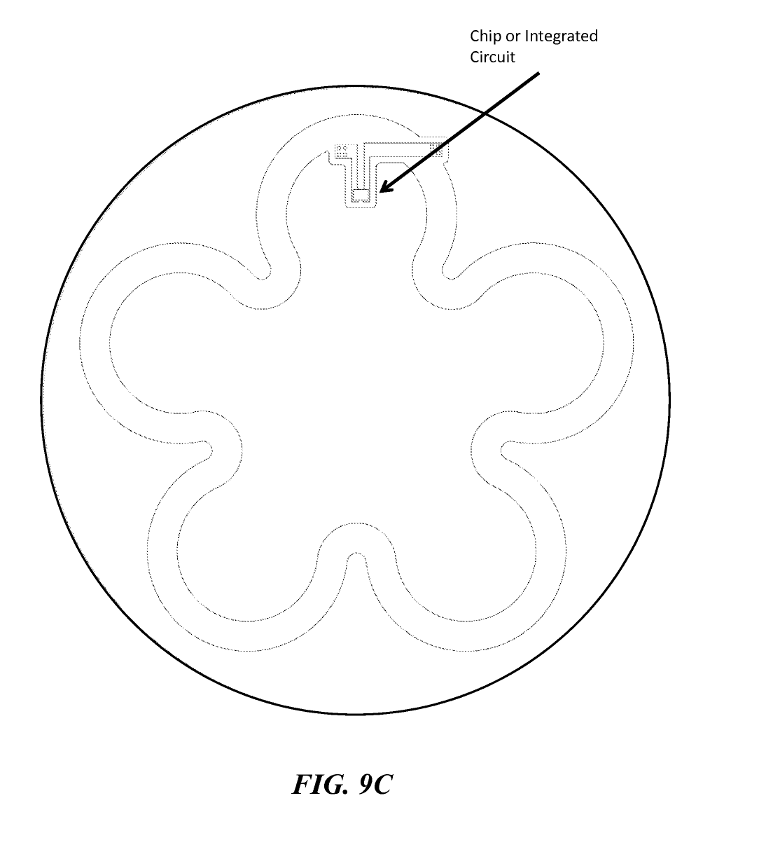

FIG. 9A shows a top down view of a flexible antenna 100 in accordance with some embodiments of the invention, and FIG. 9B shows a view from an opposite side of the same flexible antenna 100. The flexible antenna 100 can include a base substrate 110, and a plurality of metal loops 120 (e.g., 2, 3, 4, 5, 6, 7, 8, 9, 10, or more) arranged in a concentric manner and disposed on a first side of the base substrate 110. In accordance with some embodiments of the invention, the space between the metal loops can be sufficient to avoid shorting during use and flexing or stretching. In accordance with some embodiments of the invention, the metal loops 120 can be equally spaced by a distance on the order of microns, for example, by 5 μm to 100 μm, 10 μm to 80 μm, 10 μm to 60 μm, or 10 μm to 50 μm. In accordance with some embodiments of the invention, the spacing between the metal loops 120 can vary. In accordance with the width and height of each of the metal loops can be selected based on the current carrying requirements of the circuit and the physical or structural requirements of the device. In accordance with some embodiments, each one of the metal loops can have a width in the range of 100 nm to 300 μm, 200 nm to 200 μm, 500 nm to 100 μm, 500 nm to 50 μm, 500 nm to 25 μm, 500 nm to 10 μm, or 1 μm to 50 μm. In accordance with some embodiments, each one of the metal loops can have a height in the range of 100 nm to 300 μm, 200 nm to 200 μm, 500 nm to 100 μm, 500 nm to 50 μm, 500 nm to 25 μm, 500 nm to 10 μm, or 1 μm to 50 μm.

Each of the plurality of metal loops 120 can be electrically connected, thereby forming an induction coil and/or an antenna. The plurality of metal loops 120 can comprise a starting point 126 and an ending point 128. To form the metal loops 120, a continuous metal trace can start from the starting point 126, form a plurality of loops, and terminate at the ending point 128. In accordance with some embodiments of the invention, the starting point 126 is electrically connected to at least one via (e.g., a through hole) 150. The via permits the antenna 100 to be electrically connected to a chip or an integrated circuit on a second side of the base substrate 110. In accordance with some embodiments of the invention, the ending point 128 is electrically connected to at least one via (i.e., through hole) 152. In accordance with some embodiments of the invention, the starting point 126 can be electrically connected to at least one solder pad to facilitate a solder connection to a chip, an integrated circuit or another electronic device. In accordance with some embodiments of the invention, the ending point 128 can be electrically connected to at least one solder pad to facilitate a solder connection to a chip, an integrated circuit or another electronic device.

As shown in FIGS. 3, 9A, 9B, 9C, each one of the metal loops 120 can be divided into a plurality of arc segments (e.g., 2, 3, 4, 5, 6, 7, 8, 9, 10, or more), each of which comprises an arc center. The arc segments can be classified into two types: an inner arc segment 122 which has an arc center outside the metal loop, and an outer arc segment 124 which has an arc center inside the metal loop. The plurality of arc segments can comprise alternating inner arc segments and outer arc segments. The arc centers inside the metal loops can be arranged in a geometric pattern such as a rectangular, circular, elliptical, oval, octagonal, hexagonal, and pentagonal pattern. Similarly, the arc centers outside the metal loops can also be arranged in a geometric pattern such as a rectangular, circular, elliptical, oval, octagonal, hexagonal, and pentagonal pattern.

In accordance with some embodiments of the invention, the outer arc segments 124 of the same loop have substantially similar radii. In accordance with some embodiments of the invention, the inner arc segments 122 of the same loop have substantially similar radii.

In accordance with some embodiments of the invention, the radius of an inner arc segment 122 is smaller than that of an adjacent outer arc segment 124 of the same loop, for example, by at least 2%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90%. In accordance with some embodiments of the invention, the radius of an inner arc segment 122 is equal to that of an adjacent outer arc segment 124. In accordance with some embodiments of the invention, the radius of an inner arc segment 122 is larger than that of an adjacent outer arc segment 124, for example, by at least 2%, at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, or at least 90%.

While the flexible antenna 100 shown in FIG. 9A includes 5 inner arc segments and 5 outer arc segments, other segment numbers can be used. For example, the number of inner arc segments can be 2, 3, 4, 5, 6, 7, 8, 9, 10, or more; and the number of outer arc segments can be 2, 3, 4, 5, 6, 7, 8, 9, 10, or more. It should be noted that the number of inner arc segments does not have to be the same as the number of outer arc segments.

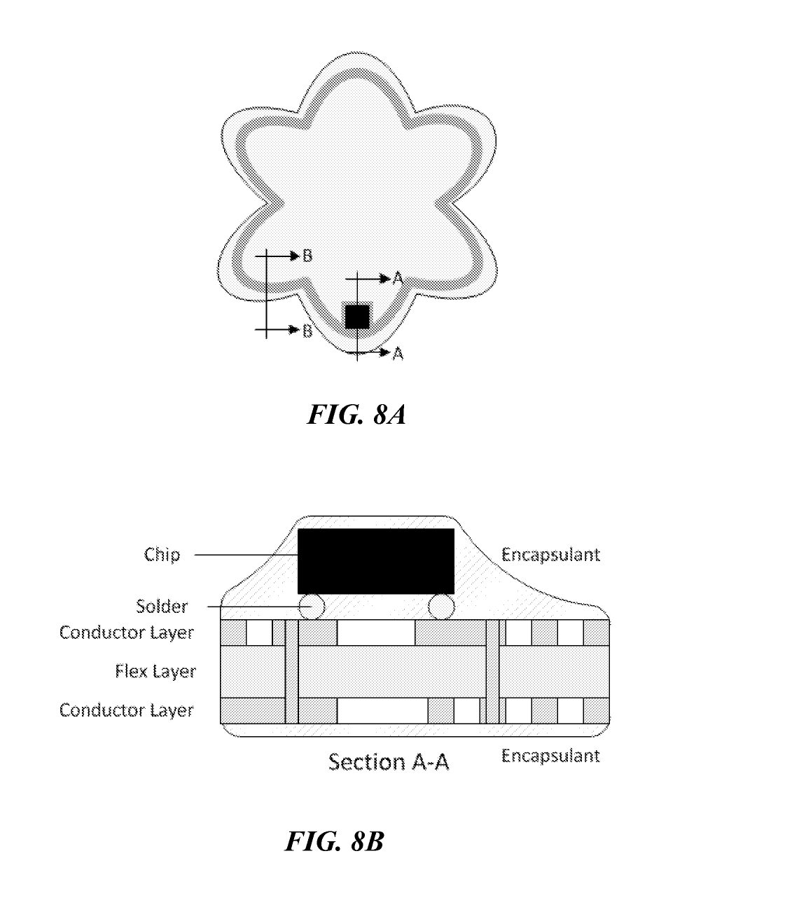

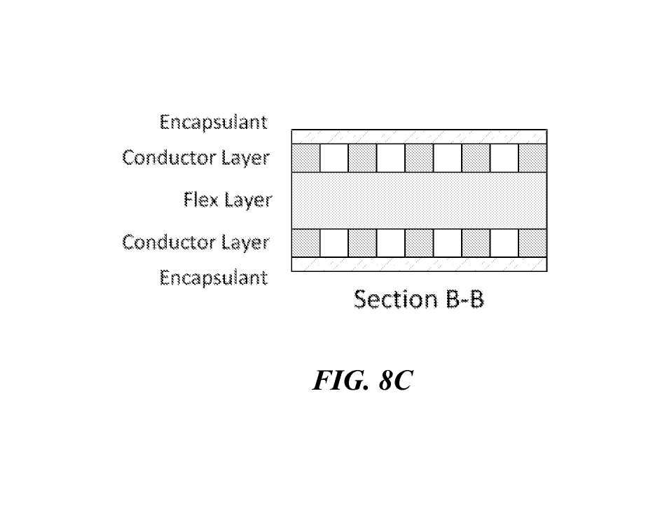

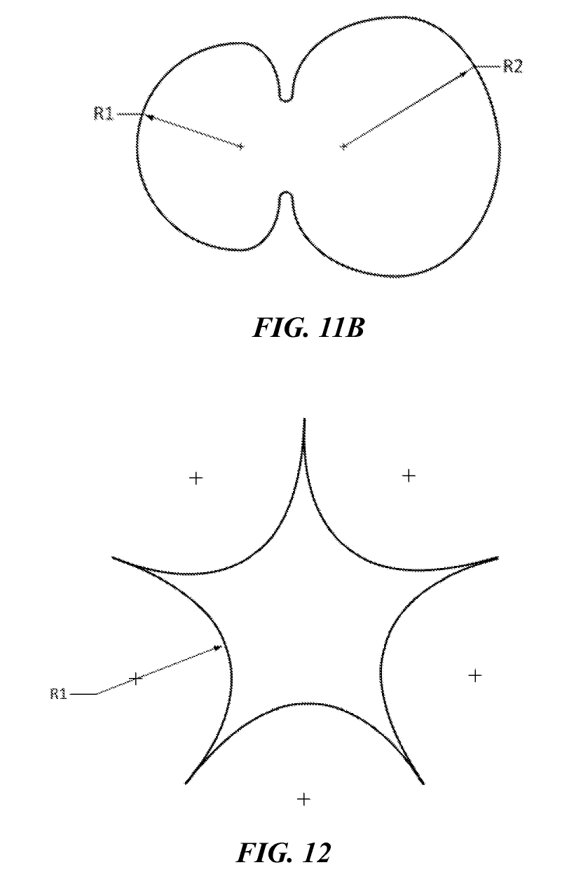

In accordance with some embodiments of the invention, all the arc centers can be inside the metal loop, for example, see FIG. 8A. In accordance with some embodiments of the invention, all the arc centers can be outside the metal loop, for example, see FIG. 12. In accordance with some embodiments of the invention, some arc centers can be inside the metal loop and some arc centers can be outside the metal loop. In accordance with some embodiments of the invention, two neighboring arcs can have the same arc center, for example see FIG. 11A. In accordance with some embodiments of the invention, two neighboring arcs can have two different arc centers.

The base substrate 110 can have a thickness of no more than 300 μm. Generally, thin base substrates are preferred as they tend to be more flexible and in some embodiments, the base substrate can be omitted or removed. Preferably, the thickness of the base substrate 110 is no more than 250 μm, no more than 200 μm, no more than 150 μm, no more than 100 μm, no more than 50 μm, or no more than 25 μm. The base substrate 110 can be physically separated into a plurality of singulated substrates (e.g., 2, 3, 4, 5, 6, 7, 8, 9, 10, or more), wherein at least one metal loop is disposed on each singulated substrate. As an illustrative example, when there are 10 metal loops and 2 singulated substrates, one singulated substrate can have 1, 2, 3, 4, 5, 6, 7, 8, or 9 metal loops disposed thereon, while the other singulated substrate can have 9, 8, 7, 6, 5, 4, 3, 2, or 1 metal loops disposed thereon respectively. In accordance with some embodiments, the singulated substrates can be spaced by 5 μm to 500 μm, 10 μm to 400 μm, 10 μm to 300 μm, 10 μm to 200 μm, 10 μm to 150 μm, 10 μm to 100 μm, or 10 μm to 50 μm. In accordance with some embodiments, some or all of the singulated substrates can be direct contact with no space between them. The singulated substrates can be substantially separated from each other, and are connected where adjacent metal loops are connected.

The width of the base substrate should be sufficient to accommodate the metal loops. In accordance with some embodiments of the invention, the radii of the inner arc segments and/or outer arc segments are greater than the width of the substrate having the metal loop disposed thereon.

In accordance with some embodiments of the invention, the flexible antenna 100 can optionally include a cutout 130 where a portion of the base substrate 110 inside the innermost metal loop can be removed. For example, at least 5%, at least 10%, at least 20%, at least 30%, at least 40%, at least 50%, at least 60%, at least 70%, at least 80%, or at least 90% of the base substrate material inside the innermost metal loop is removed. As used herein, the term “innermost metal loop” refers to the first metal loop formed by the metal trace starting at the starting point 126. The cutout 130 can have any geometric shape. For example, the cutout 130 can have a shape that is substantially similar to the shape of the metal loops 120. The cutout 130 can have a predefined shape (e.g., a predefined geometric or abstract shape) that facilitates stacking and/or storing the electronic device.

In accordance with some embodiments of the invention, the flexible antenna 100 can comprise 2, 3, 4, 5, 6, 7, 8, 9, 10, or more base substrates stacked on top of each other, wherein a plurality of metal loops 120 (e.g., 2, 3, 4, 5, 6, 7, 8, 9, 10, or more) are arranged in a concentric manner and disposed on each of the base substrate. The vias of each of the base substrates can be aligned and connected to permit electrical connection between all the metal loops. Varying the number of metal loops can be used to adjust the electrical properties of the antenna, such as the inductance and the mutual inductance to the antenna from the reading components.

The lateral dimension of the flexible antenna 100 can be on the order of millimeters, for example, in the range of 5 mm to 45 mm, 10 mm to 40 mm, or 25 mm to 35 mm.

As shown in FIG. 9B, the flexible antenna 100 can include a second side of the base substrate 110, vias 150 and 152, a first solder pad or electrode 160, and a second solder pad or electrode 162. The via 150 can be electrically connected to the first electrode 160, and the via 152 can be electrically connected to the second electrode 162. A chip or an integrated circuit can be electrically connected (such as by soldering or bonding wires) to the first electrode 160 and the second electrode 162, such that the antenna 100 can provide power and wireless signals to the chip or integrated circuit. In accordance with some embodiments of the invention, a plurality of metal loops (e.g., 2, 3, 4, 5, 6, 7, 8, 9, 10, or more) can be arranged in a concentric manner and disposed on the second side of the base substrate 110.

In accordance with some embodiments of the invention, the flexible antenna 100 can be sandwiched between an encapsulation layer 142 (shown in FIG. 9B) and an adhesive layer 140 (shown in FIG. 9A). The encapsulation layer 142 offers multiple functions. For example, the encapsulation layer 142 can provide mechanical protection, device isolation, and the like. The encapsulation layer 142 can have a significant benefit to stretchable electronics. For example, low modulus PDMS or silicone structures can increase the range of stretchability significantly. The encapsulation layer 142 can also be used as a passivation later on top of devices for the protection or electrical isolation. The encapsulation layer 142 can also relieve strains and stresses on the electronic device, such as the antenna of the device that is vulnerable to strain induced failure. The adhesive layer 140 permits the flexible antenna 100 to be affixed on and conform to a surface, such as the skin or a device or garment. The adhesive layer 140 and/or encapsulation layer 142 can further include a release liner. The adhesive layer 140 and encapsulation layer 142 can each independently have a shape such as rectangular, circular, elliptical, oval, octagonal, hexagonal, and pentagonal.

In accordance with some embodiments of the invention, the flexible antenna 100 can be embedded or encapsulated in an encapsulation layer, such that flexing the encapsulation layer flexes the antenna 100. The encapsulation layer can be further in contact with an adhesive layer.

Mechanical modeling can be used to determine the mechanical strains and weak points in the flexible antenna, and guide the antenna design. Mechanical stress thresholds for each arc segment of the metal loops can be accordingly engineered and controlled. Mechanical stress weak points can be purposely included in the antenna to ensure that the antenna physically breaks when a certain mechanical stress threshold is reached. This can be used as a security feature for NFC or RFID labels with the antennas designed to break and stop functioning when they are removed from the skin or the surface of a device. In this embodiment, the adhesive layer 142 can be sufficiently strong such that the force required to remove the device from surface is sufficiently large enough to cause the strain threshold of the device (e.g., resulting in breakage) to be exceed upon removal. Alternatively, the device 100 can be placed on or attached to a flexible surface, band or fabric whereby stretching the surface, band or fabric beyond a predefined amount can cause the antenna to break.

The flexible antenna described herein can be electrically connected to one or more chips or integrated circuits (FIG. 9C) for short-range wireless communication such as near field communication (NFC), bluetooth, zigbee, radio-frequency identification (RFID), and infrared transmission. The chip or integrated circuit can perform one or more functions. For example, the chip or integrated circuit can produce a signal for authentication. Accordingly, one aspect of the invention relates to a flexible device comprising the flexible antenna described herein and a chip or an integrated circuit electrically connected to the antenna. In accordance with other embodiments of the invention, the flexible device can be sandwiched between an encapsulation layer and an adhesive layer. The adhesive layer permits the flexible device to be affixed on a surface, such as the skin, a device or a fabric. The adhesive layer can further include a release liner. In accordance with some embodiments of the invention, the chip or integrated circuit can be in contact with the adhesive layer. In accordance with other embodiments of the invention, the chip or integrated circuit is in contact with the encapsulation layer. Optionally, graphics (e.g., images and/or indicia) can be printed on the surface of or embedded in the encapsulation layer, the adhesive layer or both. In accordance with some embodiments of the invention, the graphics can fluorescent, phosphorescent, luminescent (e.g., glows in the dark) or otherwise light or heat sensitive (e.g., changes in one or more characteristics as function of exposure to light and/or heat). For example, in accordance with some embodiments, at least a portion of the ink used to apply the graphics can change color as a function of exposure or duration of exposure to heat or light or other electromagnetic radiation.

In accordance with some embodiments of the invention, the flexible device can be embedded or encapsulated in an encapsulation layer. The encapsulation layer can be further in contact with an adhesive layer.

Chips or integrated circuits for short-range wireless communication are known in the art and are not described in detail here. In accordance with some embodiments of the invention, the flexible device can include two or more chips or integrated circuits, which can be optionally electrically connected by wires or using wireless signals.

The flexible electronic devices according to the invention can be configured without an on-board power source, enabling the degree of conformality of the flexible electronic device can be greatly increased. The flexible electronic devices herein can be configured in new form factors allowing the creation of very thin and flexible or stretchable electronic devices. As a non-limiting example, the average thickness of the flexible electronic device can be about 2.5 mm or less, about 2 mm or less, about 1.5 mm or less, about 1 mm or less, about 500 microns or less, about 100 microns or less, about 75 microns or less, about 50 microns or less, or about 25 microns or less. In an example implementation, at least a portion of the electronic device can be folded, or the electronic device can be caused to surround and conform to a portion of an irregular surface. In an example where at least a portion of the electronic device is folded, the average thickness of the electronic device may be about 5 mm or less, about 4 mm or less, about 3 mm or less, about 2 mm or less, about 1 mm or less, about 200 microns or less, about 150 microns or less, about 100 microns or less, or about 50 microns or less. The lateral, in-plane dimensions can be varied based on the desired application. For example, the lateral dimensions can be on the order of centimeters or fractions of a centimeter. In other examples, the flexible or stretchable electronic devices can be configured to have other dimensions, form factors, and/or aspect ratios (e.g., thinner, thicker, wider, narrower, or many other variations).

In accordance with some embodiments of the invention, the flexible antenna or device comprising the antenna can also be stretchable. In accordance with some embodiments of the invention, the flexible antenna or device comprising the antenna can conform to any surface (e.g., on a human or animal body or an irregular shaped device) to which it is applied. In accordance with some embodiments of the invention, the flexible antenna or device comprising the antenna can be substantially planar or flat in a resting state. In accordance with some embodiments of the invention, the flexible antenna or device comprising the antenna can be curved in a resting state, e.g., as on a curved surface, such as a ball or handle.

Functionality tests can be run to examine the mechanical properties and functions of the device. For example, the functionality test can be a reading of the unique identification (UID) of each NFC chip. The distance (“working distance”) between the reader plane and the antenna/NFC chip plane can be varied, measured and recorded for the measurement. A similar NFC functionality test can be performed during and/or after the fabrication process. The test set up can be the same as used for other measurements. Besides reading out the UID for each chip, certain customized writing to each chip can be used per custom specification. The writing step can be performed using the same reader. For both the reading and the writing steps, batch type process is possible by using readers with large area antennas.

### Materials and Manufacture

It should also be noted that materials can be chosen based on their properties which include degree of stiffness, degree of flexibility, degree of elasticity, or such properties related to the material's elastic moduli including Young's modulus, tensile modulus, bulk modulus, shear modulus, etc., and or their biodegradability.

In an example where the flexible antenna or device includes a non-conductive material, the non-conductive material can be formed from any material having elastic (e.g., flexible and/or stretchable) properties, subject to the described relationship of elastic properties required for each overall flexible device. For example, the non-conductive material can be formed from a polymer or polymeric material. Non-limiting examples of applicable polymers or polymeric materials include, but are not limited to, a polyimide (PI), a polyethylene terephthalate (PET), a silicone, plastics, elastomers, thermoplastic elastomers, elastoplastics, thermostats, thermoplastics, acrylates, acetal polymers, biodegradable polymers, cellulosic polymers, fluoropolymers, nylons, polyacrylonitrile polymers, polyamide-imide polymers, polyarylates, polybenzimidazole, polybutylene, polycarbonate, polyesters, polyetherimide, polyethylene, polyethylene copolymers and modified polyethylenes, polyketones, poly(methyl methacrylate, polymethylpentene, polyphenylene oxides and polyphenylene sulfides, polyphthalamide, polypropylene, polyurethanes, styrenic resins, sulphone based resins, vinyl-based resins, or any combinations of these materials. In an example, a polymer or polymeric material herein can be a UV curable polymer. Any exemplary non-conductive material described herein can be used as an encapsulant material or other isolation material.

In accordance with some embodiments of the invention, the base substrate can comprised of a polymer. A variety of polymeric materials can be suitable for forming the base substrate. Exemplary materials include, but are not limited to, polyimide, polyethylene terephthalate, polyethylene naphthalate, polyester, polyurethane, polycarbonate, polyethersulfone, cyclic olefin polymer, polyarylates, or a combination thereof Preferably, the material can be flexible and/or stretchable at the thickness specified herein. In accordance with some embodiments of the invention, the base substrate can serve as the encapsulation layer.

A variety of polymeric materials can be suitable for forming the encapsulation layer. The encapsulation layer can be flexible and or stretchable at the thickness specified herein. Preferably, the encapsulation layer is stretchable and/or breathable, i.e., gas or air permeable. The breathable encapsulation layer allows oxygen to pass onto the skin while allowing moisture to pass out the breathable encapsulation layer, and blocks water, dirt and other particles. In accordance with some embodiments of the invention, the encapsulation layer can be comprised of an elastomer. Useful elastomers include those comprising polymers, copolymers, composite materials or mixtures of polymers and copolymers. Useful elastomers include, but are not limited to, thermoplastic elastomers, styrenic materials, olefenic materials, polyolefin, polyurethane thermoplastic elastomers, polyamides, polyimides synthetic rubbers, PDMS, polybutadiene, polyisobutylene, poly(styrene-butadiene-styrene), polyurethanes, polychloroprene and silicones. In accordance with some embodiments of the invention, the encapsulation layer can serve as the base substrate. In accordance with some embodiments of the invention, the encapsulant can be an adhesive.

In accordance with some embodiments, the adhesive layer can be breathable. In accordance with some embodiments of the invention, the adhesive layer is comprised of a skin adhesive. Suitable adhesives include acrylic-based, dextrin based, and urethane based adhesives as well as natural and synthetic elastomers. Suitable examples include amorphous polyolefins (e.g., including amorphous polypropylene), Kraton® Brand synthetic elastomers, and natural rubber. Other exemplary skin adhesives include cyanoacrylates, hydrocolloid adhesives, hydrogel adhesives, and soft silicone adhesives. In accordance with some embodiments of the invention, the skin adhesive is FLEXCON DERMAFLEX™ H-566 with release liner. In accordance with some embodiments, the adhesive can be reusable, enabling the device to be removed and reapplied or relocated and applied to different surface.

In an example where the flexible antenna or device includes a conductive material, the conductive material can be, but is not limited to a metal, a metal alloy, silver paste, paste with metallic nanoparticles, a conductive polymer, or other conductive material. In an example, the metal or metal alloy of the conductive material can include but is not limited to aluminum, stainless steel, or a transition metal (including copper, silver, gold, platinum, zinc, nickel, titanium, chromium, or palladium, or any combination thereof) and any applicable metal alloy, including alloys with carbon. In other non-limiting example, suitable conductive materials can include a semiconductor-based conductive material, including a silicon-based conductive material, indium tin oxide or other transparent conductive oxide, or Group III-IV conductor (including GaAs). The semiconductor-based conductive material can be doped. Preferably, the conductive material is suitable for standard microfabrication processes such as etching. In accordance with some embodiments of the invention, the metal loops can be substituted by loops comprised of a non-metal conductive material, such as carbon nanotubes, graphene, and conductive polymer. Where the metal loops are formed by a non-metal conductive material, the encapsulating layer can serve as the base substrate.

The flexible antenna or device comprising the antenna can be manufactured using standard fabrication processes such as photolithography, e-beam lithography, wet etching, reactive ion etching, material depositions (e.g., thermal deposition, e-beam deposition, chemical vapor deposition, atomic layer deposition, or physical vapor deposition), soldering, laser drilling, kiss cutting, and lamination. For example, the metal loops can be fabricated by depositing a copper layer on the base substrate, creating a pre-defined pattern. Photolithography or e-beam lithography, and wet etching can be used to remove any unwanted copper. Lamination can be used to stack a plurality of layers. The chip or integrated circuit can be soldered or wired to the antenna. Components of the flexible antenna or device can also be produced by 3-dimensional printing.

Alternatively, the antenna according to the invention can be fabricated by bonding a wire directly to the chip or integrated circuit and forming one or more loops and then bonding the end of the wire to the chip or integrated circuit as described in commonly owned U.S. Patent Application No. 62/053,641, filed on Sep. 22, 2014, entitled Methods And Apparatuses For Shaping And Looping Bonding Wires That Serve As Stretchable And Bendable Interconnects, which is hereby incorporated by reference in its entirety.

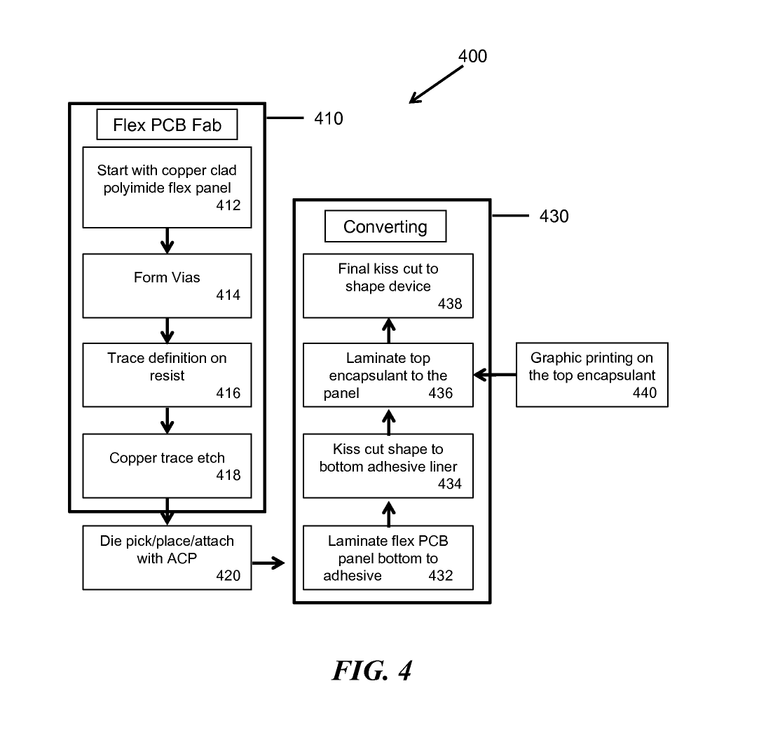

FIG. 4 provides an exemplary process for producing a flexible electronic device. These processes can be implemented for high volume manufacturing with viable cost reduction avenues. For example, as shown in FIGS. 8A-8C, one or more flexible polyimide layers can each be cladded with two copper layers; an antenna comprising copper loops can be produced on the polyimide layer by lithography (e.g., e-beam lithography or photolithography) and subsequent etching; if there are two or more flexible polyimide layers, the layers can be laminated and vias can be created by, e.g., laser drilling; an electronic component such as a chip or integrated circuit can be electrically connected to the antenna by soldering or wire bonding; and the device can then be encapsulated in a flexible and/or stretchable material such as silicone or thermoplastic polyurethane. An adhesive material can also be applied to one surface to facilitate adhesion to the skin of a person or animal or the surface of an object.

### Methods of Use

According to the example systems, methods, and devices described herein, technology is provided for qualitative and/or quantitative analysis using the flexible electronic devices that include no power source or a low-power source. As a non-limiting example, the low-power source could be power source providing lower than about 25 mAH, about 20 mAH, about 15 mAH, about 10 mAH, about 5 mAH, or about 1 mAH. In an example, the low-power source could provide lower than about 5 mA peak current, such as but not limited to a thin-film battery with sub-5 mA peak current. The flexible electronic devices can be configured for user authentication, mobile payments, and/or location tracking.

Any of the example methods according to the principles described herein can be implemented using a device that includes a higher-power source, where the power source is maintained dormant or used minimally to replicate the state of an example electronic device according to the principles described herein.

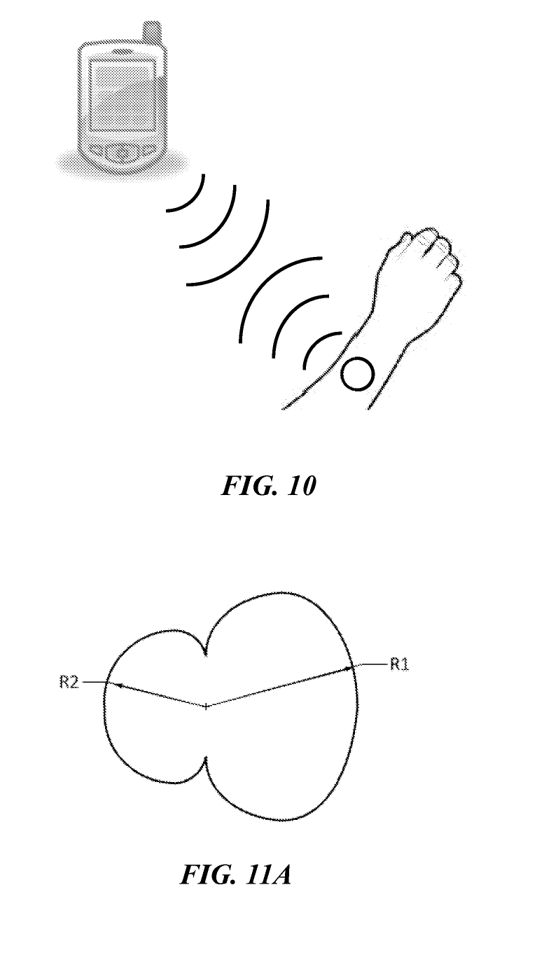

FIG. 10 is a schematic showing the operation of a flexible device in accordance with some embodiments of the invention. The flexible device can be mounted to the skin of a person, for example, on the forearm. A computing device is at a distance from the flexible device suitable for short-range wireless communication. For example, NFC is a set of short-range wireless technologies, typically requiring a distance of 10 cm or less. The computing device can produce a signal (e.g., an electromagnetic wave) receivable by the flexible device, the antenna of which can generate an electrical current in response to the signal. The electrical current can then power the chip or integrated circuit of the flexible device to produce an outgoing signal, which can be received by the same computing device or a different device. The outgoing signal can be used to perform one or more desirable functions (including user authentication, mobile payments, and/or location tracking).

In accordance with some embodiments of the invention, the flexible device mounted to the skin of a person can remain functional while flexing and/or stretching according to the movement of the skin. The flexible device can be breathable enabling it to be worn for long periods of time, on the order of days, weeks or months.

The flexible electronic devices herein can be configured as a single-use device. For example, the device can stay functional when it is on the skin of a user, but will stop its functions once it is removed from the skin, for example, because the metal loops of the antenna, by design, break.

The flexible electronic devices herein can be configured as a device that can be used for performing two or more qualitative and/or quantitative measurements (a multi-use device). For example, the device may be configured as a re-usable, lower-cost system for performing the example functions described herein (including user authentication, mobile payments, and/or location tracking) As a result, the flexible electronic devices can provide environmental benefits.

The example systems, methods, and devices described herein can facilitate energy harvesting from computing devices, such as but not limited to, smartphones, for powering data gathering and/or analysis systems. Non-limiting examples of a computing device applicable to any of the example systems, devices or methods according to the principles herein include smartphones, tablets, laptops, slates, e-readers or other electronic reader or hand-held, portable, or wearable computing device, an Xbox®, a Wii®, or other game system(s).

The example systems, methods, and devices described herein also provide innovations in the design of power circuitry, by substantially eliminating the need for an on-board power source. This facilitates many innovative and different designs of the power circuitry of a system.

The example systems, methods, and devices described herein also provide innovative methods to guide a user to deploy the flexible electronic devices in a convenient manner that facilitates energy harvesting.

Re-usable low-cost systems, with reduced operating costs, can be produced using the example systems, methods, and devices described herein. Novel power circuitry designs are described. Novel startup sequences are also described that carefully parcel out energy in small quanta to allow full system power. The low-cost systems can be used for intermittent monitoring applications, where continuous monitoring may not be needed. For example, the systems herein can be used to store harvested energy for short period of time, sufficient to allow the flexible electronic devices to perform the data gathering and/or data analysis. In another example, a portion of the energy can be used for to perform data storage and/or data transmission.

In any of the flexible electronic devices according to the systems, methods, and devices described herein, data can be transmitted to a memory of the system and/or communicated (transmitted) to an external memory or other storage device, a network, and/or an off-board computing device. In any example herein, the external storage device can be a server, including a server in a data center.

Any of the flexible electronic devices described herein can be configured for intermittent use.

Any of the flexible electronic devices described herein can be configured as sensor units, sensor patches, monitoring devices, diagnostic devices, therapy devices, or any other electronic device that can be operated using harvested energy as described herein. As a non-limiting example, the example electronic device can be a user authentication, mobile payments, and/or location tracking electronic device. Other applications include, but are not limited to, heart-rate monitoring, motion sensing, and sleep monitoring.

In any example according to the principles herein, the flexible electronic device can be configured as flexible conformal electronic devices with modulated conformality. The control over the conformality allows the generation of electronic devices that can be conformed to the contours of a surface without disruption of the functional or electronic properties of the electronic device. The conformality of the overall example electronic device can be controlled and modulated based on the degree of flexibility and/or stretchability of the structure. Non-limiting examples of components of the conformal electronic devices include a processing unit, a memory (such as but not limited to a read-only memory, a flash memory, and/or a random-access memory), an input interface, an output interface, a communication module, a passive circuit component, an active circuit component, etc. In an example, the conformal electronic device can include at least one microcontroller and/or other integrated circuit component. In an example, the conformal electronic device can include at least one coil, such as but not limited to a near-field communication (NFC) enabled coil. In another example, the conformal electronic device can include a radio-frequency identification (RFID) component.

In accordance with some embodiments of the invention, the conformal electronic devices includes a dynamic NFC/RFID tag integrated circuit with a dual-interface, electrically erasable programmable memory (EEPROM).

The conformal electronic device can be configured with the one or more device islands. The arrangement of the device islands can be determined based on, e.g., the type of components that are incorporated in the overall flexible electronic device (including the sensor system), the intended dimensions of the overall flexible electronic device, and the intended degree of conformality of the overall flexible electronic device.

As a non-limiting example, the configuration of the one or more device islands can be determined based on the type of overall flexible electronic device to be constructed. For example, the overall flexible electronic device can be a wearable and conformal electronic structure, or a passive or active electronic structure that is to be disposed in a flexible and/or stretchable object.

As another non-limiting example, the configuration of the one or more device islands of the flexible electronic device can be determined based on the components to be used in an intended application of the overall electronic device. Other example applications include a temperature sensor, a neuro-sensor, a hydration sensor, a heart sensor, a motion sensor, a flow sensor, a pressure sensor, an equipment monitor (e.g., smart equipment), a respiratory rhythm monitor, a skin conductance monitor, an electrical contact, or any combination thereof. In an example, the one or more device islands can be configured to include at least one multifunctional sensor, including a temperature, strain, and/or electrophysiological sensor, a combined motion-/heart/neuro-sensor, a combined heart-/temperature-sensor, etc.

The flexible electronic devices can be configured to include no power source, or a power source that provides little power source, to perform one or more desirable functions (including user authentication, mobile payments, and/or location tracking) As a result, the flexible electronic devices can be made lower-cost, based on the reduced cost or no cost expended for a power source component, or the avoidance or reduction of costs associated with caring for or charging the power source. The flexible electronic devices can be less complex, due to the fewer or more simplified components in the structure, and as a result could be manufactured in a lower cost fabrication process. Given that the flexible electronic devices can be produced with no power component or a lower-power component, the flexible electronic devices can be more environment friendly as fewer materials are needed.

Non-limiting examples of power sources applicable to the example electronic devices herein include batteries, fuel cells, solar cells, capacitors, supercapacitors, and thermoelectric devices. Non-limiting examples of batteries include bulk low-leakage batteries and thin-film batteries.

In accordance with some embodiments of the invention, the flexible electronic device can derive power for performing quantitative measurements through energy harvesting. The energy harvesting component of the flexible electronic device can be any component that can be used to transduce one form of energy to another form of energy (such as but not limited to electrical energy). In some examples, the device can be configured to derive power for performing the example functions described herein (including user authentication, mobile payments, and/or location tracking) by energy harvesting from thermal gradients, mechanical vibrations, transverse waves and/or longitudinal waves. The transverse waves or longitudinal waves can be generated by at least one component of an external computing device. The energy harvesting component of the flexible electronic device is the antenna described herein. Other examples of energy harvesting components suitable for flexible electronic devices can be a metamaterial, an optoelectronic device, a thermoelectric device, a resonator, or other component that can be configured to couple to a form of energy.

As a non-limiting example, the transverse waves can be electromagnetic waves or acoustic waves. As a non-limiting example, the longitudinal waves can be acoustic waves.

In accordance with some embodiments of the invention, the device can be configured to derive power for performing the example functions described herein (including user authentication, mobile payments, and/or location tracking) by energy harvesting based on radio waves from an external computing device. In this example, a surface acoustic wave technology may be implemented in the flexible electronic device to exploit a piezoelectric effect to convert the acoustic wave into an electrical signal. For example, the surface acoustic wave sensor can include an interdigital transducer for the conversion.

In accordance with some embodiments of the invention, the electronic device can include a capacitive component, and the harvested power can be used to charge the capacitive component. In some examples, the capacitive component can be a low-leakage capacitor or a super capacitor. Non-limiting examples of the low-leakage capacitors applicable to any system or apparatus herein include an aluminum electrolytic capacitor, an aluminum polymer capacitor, or an ultra-low leakage tantalum capacitor. For some example implementations, the aluminum electrolytic capacitor can be a better selection than the ultra-low leakage tantalum capacitors. A supercapacitor can provide a higher charge-density than an electrolytic or tantalum capacitors, and can be useful for implementations that require delivery of bursts of current. In accordance with some embodiments of the invention, the supercapacitor can be an electrochemical capacitor. In accordance with some embodiments of the invention, the supercapacitors can be used to supplement or replace power sources such as batteries, including Li⁺ batteries, NiCd batteries, NiMH batteries, or other similar types of power sources. The example measurement device can be configured to commence the example functions described herein (including user authentication, mobile payments, and/or location tracking) using the power stored to the energy-retaining component.

Given that the flexible electronic devices including no power source or a low-power source can be operated according to the principles described herein, the components can be arranged in many novel and different conformations. For example, the components of the power circuitry can be arranged in many different configurations.

As a non-limiting example, the data from the performance of the example functions described herein (including user authentication, mobile payments, and/or location tracking) can include metadata in connection with the data collection (including an indication of when the data was collected and/or where the data reading occurred). The data collected can be made accessible, with properly secured content, to, e.g., a patient, medical doctors, health professionals, sports medicine practitioners, physical therapists, locator services, payment processing agencies, etc.

It should be understood that this invention is not limited to the particular methodology, protocols, and reagents, etc., disclosed herein and as such may vary. The terminology used herein is for the purpose of describing particular embodiments only, and is not intended to limit the scope of the present invention, which is defined solely by the claims.

As used herein and in the claims, the singular forms include the plural reference and vice versa unless the context clearly indicates otherwise. Other than in the operating examples, or where otherwise indicated, all numbers expressing quantities of ingredients or reaction conditions used herein should be understood as modified in all instances by the term “about.”

Although any known methods, devices, and materials may be used in the practice or testing of the invention, the methods, devices, and materials in this regard are disclosed herein.

Some embodiments of the invention are listed in the following numbered paragraphs:
paragraph 1. A flexible antenna comprising
a base substrate; and

a first plurality of metal loops arranged in a concentric manner and disposed on a first side of the base substrate, wherein:
(i) the metal loops are electrically connected, whereby electrical connectivity is maintained during flexing; and
(ii) each metal loop comprises at least two arc segments, each arc segment having an arc center and a radius, wherein the radius of one arc segment is greater than the radius of at least one other arc segment.
paragraph 2. The flexible antenna of paragraph 1, wherein the arc centers alternate between being inside the metal loop and outside the metal loop.
paragraph 3. The flexible antenna of paragraph 1, wherein all the arc centers are inside the metal loop.
paragraph 4. The flexible antenna of paragraph 1, wherein all the arc centers are outside the metal loop.
paragraph 5. The flexible antenna of paragraph 1, wherein the antenna is substantially planar in a resting state.
paragraph 6. The flexible antenna of paragraph 2 or 3, wherein the arc centers inside the metal loop are arranged in a geometric pattern.
paragraph 7. The flexible antenna of paragraph 2 or 4, wherein the arc centers outside the metal loop are arranged in a geometric pattern.
paragraph 8. The flexible antenna of paragraph 6 or 7, wherein the geometric pattern is rectangular, circular, elliptical, oval, octagonal, hexagonal, or pentagonal.
paragraph 9. The flexible antenna of paragraph 1, wherein a portion of the base substrate inside the metal loops is removed, thereby permitting the antenna to be stretchable.
paragraph 10. The flexible antenna of paragraph 1, wherein the base substrate is physically separated into a plurality of singulated substrates, wherein at least one metal loop is disposed on each singulated substrate.
paragraph 11. The flexible antenna of paragraph 1, wherein the base substrate has a thickness of no more than 100 μm.
paragraph 12. The flexible antenna of paragraph 1, wherein each metal loop has a thickness of no more than 100 μm.
paragraph 13. The flexible antenna of paragraph 1, wherein each arc segment of the metal loop has a radius greater than the width of the substrate having the metal loop disposed thereon.
paragraph 14. The flexible antenna of paragraph 1, wherein the antenna conforms to a surface to which it is applied.
paragraph 15. The flexible antenna of paragraph 1, wherein the antenna permits short-range wireless communication.
paragraph 16. The flexible antenna of paragraph 15, wherein the short-range wireless communication is near field communication (NFC) or radio-frequency identification (RFID).
paragraph 17. The flexible antenna of paragraph 1, wherein each metal loop is comprised of a metal selected from the group consisting of copper, aluminum, gold, platinum, silver, silver paste, and paste with metallic nanoparticles.
paragraph 18. The flexible antenna of paragraph 1, wherein the base substrate is comprised of polyimide, polyethylene terephthalate, polyester, polyurethane, polycarbonate, or a combination thereof.
paragraph 19. The flexible antenna of paragraph 1, further comprising a second plurality of metal loops arranged in a concentric manner and disposed on a second side of the base substrate, wherein the second plurality of metal loops are electrically connected to the first plurality of metal loops.
paragraph 20. The flexible antenna of paragraph 1, further comprising an encapsulation layer and an adhesive layer, wherein the base substrate and the first plurality of metal loops are sandwiched between the encapsulation layer and the adhesive layer.
paragraph 21. The flexible antenna of paragraph 20, wherein the encapsulation layer and/or the adhesive layer is gas permeable.
paragraph 22. The flexible antenna of paragraph 1, further comprising an encapsulation layer, wherein the encapsulation layer embeds the base substrate and the first plurality of metal loops, whereby flexing the encapsulation layer flexes the antenna.
paragraph 23. The flexible antenna of paragraph 1, further comprising at least one mechanical stress weak point that can break when a certain mechanical stress threshold is reached.
paragraph 24. The flexible antenna of paragraph 2, wherein each metal loop comprises 5 arc segments having arc centers inside the metal loop, and 5 arc segments having arc centers outside the metal loop.
paragraph 25. A flexible device for short-range wireless communication comprising
(a) an antenna comprising:
a base substrate; and

a first plurality of metal loops arranged in a concentric manner and disposed on the first side of the base substrate, wherein:
(i) the metal loops are electrically connected, whereby electrical connectivity is maintained during flexing; and
(ii) each metal loop comprises at least two arc segments, each arc segment having an arc center and a radius, wherein the radius of one arc segment is greater than the radius of at least one other arc segment;
   and
(b) a chip or an integrated circuit electrically connected to the antenna.
paragraph 26. The flexible device of paragraph 25, wherein the short-range wireless communication is near field communication (NFC).
paragraph 27. The flexible device of paragraph 25, wherein the arc centers alternate between being inside the metal loop and outside the metal loop.
paragraph 28. The flexible device of paragraph 25, wherein all the arc centers are inside the metal loop.
paragraph 29. The flexible device of paragraph 25, wherein all the arc centers are outside the metal loop.
paragraph 30. The flexible device of paragraph 25, wherein the device is substantially planar in a resting state.
paragraph 31. The flexible device of paragraph 27 or 28, wherein the arc centers inside the metal loop are arranged in a geometric pattern.
paragraph 32. The flexible device of paragraph 27 or 29, wherein the arc centers outside the metal loop are arranged in a geometric pattern.
paragraph 33. The flexible device of paragraph 31 or 32, wherein the geometric pattern is rectangular, circular, elliptical, oval, octagonal, hexagonal, or pentagonal.
paragraph 34. The flexible device of paragraph 25, wherein a portion of the base substrate inside the metal loops is removed, thereby permitting the antenna to be stretchable.
paragraph 35. The flexible device of paragraph 25, wherein the base substrate is physically separated into a plurality of singulated substrates, wherein at least one metal loop is disposed on each singulated substrate.
paragraph 36. The flexible device of paragraph 25, wherein the base substrate has a thickness of no more than 100 μm.
paragraph 37. The flexible device of paragraph 25, wherein each metal loop has a thickness of no more than 100 μm.
paragraph 38. The flexible device of paragraph 25, wherein each arc segment of the metal loop has a radius greater than the width of the substrate having the metal loop disposed thereon.
paragraph 39. The flexible device of paragraph 25, wherein the device conforms to a surface to which it is applied.
paragraph 40. The flexible device of paragraph 25, wherein each metal loop is comprised of a metal selected from the group consisting of copper, aluminum, gold, platinum, silver, silver paste, and paste with metallic nanoparticles.
paragraph 41. The flexible device of paragraph 25, wherein the base substrate is comprised of polyimide, polyethylene terephthalate, polyester, polyurethane, polycarbonate, or a combination thereof.
paragraph 42. The flexible device of paragraph 25, wherein the antenna further comprises a second plurality of metal loops arranged in a concentric manner and disposed on a second side of the base substrate, wherein the second plurality of metal loops are electrically connected to the first plurality of metal loops.
paragraph 43. The flexible device of paragraph 25, further comprising an encapsulation layer and an adhesive layer, wherein the antenna and the chip or integrated circuit are sandwiched between the encapsulation layer and the adhesive layer.
paragraph 44. The flexible device of paragraph 25, further comprising an encapsulation layer, wherein the encapsulation layer embeds the antenna and the chip or integrated circuit, whereby flexing the encapsulation layer flexes the device.
paragraph 45. The flexible device of paragraph 25, wherein the antenna further comprises at least one mechanical stress weak point that can break when a certain mechanical stress threshold is reached.
paragraph 46. The flexible device of paragraph 27, wherein each metal loop comprises 5 arc segments having arc centers inside the metal loop, and 5 arc segments having arc centers outside the metal loop.

### Definitions

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Further, unless otherwise required by context, singular terms shall include pluralities and plural terms shall include the singular.

As used herein the term “comprising” or “comprises” is used in reference to compositions, methods, and respective component(s) thereof, that are useful to an embodiment, yet open to the inclusion of unspecified elements, whether useful or not.

As used herein the term “consisting essentially of” refers to those elements required for a given embodiment. The term permits the presence of elements that do not materially affect the basic and novel or functional characteristic(s) of that embodiment of the invention.

The singular terms “a,” “an,” and “the” include plural referents unless context clearly indicates otherwise. Similarly, the word “or” is intended to include “and” unless the context clearly indicates otherwise. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

The terms “flexible” and “bendable” are used synonymously in the present description and refer to the ability of a material, structure, device or device component to be deformed into a curved or bent shape without undergoing a transformation that introduces significant strain, such as strain characterizing the failure point of a material, structure, device or device component. In an exemplary embodiment, a flexible material, structure, device or device component can be deformed into a curved shape without introducing strain larger than or equal to 5%, for some applications larger than or equal to 1%, and for yet other applications larger than or equal to 0.5% in strain-sensitive regions. A used herein, some, but not necessarily all, flexible structures are also stretchable. A variety of properties provide flexible structures (e.g., device components) of the invention, including materials properties such as a low modulus, bending stiffness and flexural rigidity; physical dimensions such as small average thickness (e.g., less than 100 microns, optionally less than 10 microns and optionally less than 1 micron) and device geometries such as thin film and mesh geometries.

“Stretchable” refers to the ability of a material, structure, device or device component to be strained without undergoing fracture. In an exemplary embodiment, a stretchable material, structure, device or device component may undergo strain larger than 0.5% without fracturing, for some applications strain larger than 1% without fracturing and for yet other applications strain larger than 3% without fracturing. A used herein, many stretchable structures are also flexible. Some stretchable structures (e.g., device components) are engineered to be able to undergo compression, elongation and/or twisting so as to be able to deform without fracturing. Stretchable structures include thin film structures comprising stretchable materials, such as elastomers; bent structures capable of elongation, compression and/or twisting motion; and structures having an island—bridge geometry. Stretchable device components include structures having stretchable interconnects, such as stretchable electrical interconnects.

As used herein, the term “conformable” refers to a device, material or substrate which has a bending stiffness sufficiently low to allow the device, material or substrate to adopt a desired contour profile, for example a contour profile allowing for conformal contact with a surface having a pattern of relief or recessed features. In certain embodiments, a desired contour profile is that of a tissue in a biological environment, for example skin.

As used herein, the term “conformal contact” refers to contact established between a device and a receiving surface, which can for example be a target tissue in a biological environment. In one aspect, conformal contact involves a macroscopic adaptation of one or more surfaces (e.g., contact surfaces) of a device to the overall shape of a tissue surface. In another aspect, conformal contact involves a microscopic adaptation of one or more surfaces (e.g., contact surfaces) of a device to a tissue surface resulting in an intimate contact substantially free of voids. In an embodiment, conformal contact involves adaptation of a contact surface(s) of the device to a receiving surface(s) of a tissue such that intimate contact is achieved, for example, wherein less than 20% of the surface area of a contact surface of the device does not physically contact the receiving surface, or optionally less than 10% of a contact surface of the device does not physically contact the receiving surface, or optionally less than 5% of a contact surface of the device does not physically contact the receiving surface. In some embodiments, the tissue is skin tissue.

As used herein, the term “concentric” can mean that two or more loops follow the same path or have the same shape. Stated another way, the term “concentric” refers to the ability of two or more loops having the same shape to align next to each other either horizontally, vertically, or both. In some embodiments, the plurality of concentric loops can have a common center. In other embodiments, the plurality of concentric loops may not have a common center. For example, the plurality of concentric loops can have a common axis.

As used herein in the specification, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Other than in the operating examples, or where otherwise indicated, all numbers expressing quantities of ingredients or reaction conditions used herein should be understood as modified in all instances by the term “about.” The term “about” when used in connection with percentages may mean ±5% of the value being referred to. For example, about 100 means from 95 to 105.

Although methods and materials similar or equivalent to those disclosed herein can be used in the practice or testing of this disclosure, suitable methods and materials are described below. The term “comprises” means “includes.” The abbreviation, “e.g.” is derived from the Latin exempli gratia, and is used herein to indicate a non-limiting example. Thus, the abbreviation “e.g.” is synonymous with the term “for example.”

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow. Further, to the extent not already indicated, it will be understood by those of ordinary skill in the art that any one of the various embodiments herein described and illustrated can be further modified to incorporate features shown in any of the other embodiments disclosed herein.

All patents and other publications; including literature references, issued patents, published patent applications, and co-pending patent applications; cited throughout this application are expressly incorporated herein by reference for the purpose of describing and disclosing, for example, the methodologies described in such publications that might be used in connection with the technology disclosed herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

The description of embodiments of the disclosure is not intended to be exhaustive or to limit the disclosure to the precise form disclosed. While specific embodiments of, and examples for, the disclosure are disclosed herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments disclosed herein can be combined to provide further embodiments. Aspects of the disclosure can be modified, if necessary, to employ the compositions, functions and concepts of the above references and application to provide yet further embodiments of the disclosure.

Specific elements of any of the foregoing embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

### EXAMPLES

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

The technology disclosed herein is further illustrated by the following examples which in no way should be construed as being further limiting.

### Example 1

Provided herein are example components, the example manufacturing process and the example reliability attributes for prototyping, iterating, manufacturing and measurement using an example conformable electronic device platform that can be used for many different functions, including authentication. In an example, the descriptions and the attributes of the example electronic device in this disclosure facilitate high volume manufacturing capabilities and capacities for the example electronic device and facilitate the manufactured electronic devices meeting performance specifications.

The example electronic device can be implemented as a near-filed communication/radiofrequency identification-based (NFC/RFID-based) electronic device. In non-limiting examples, the electronic device can be mounted to an article disposed proximate to the skin, can be coupled to the skin using one or more intermediate articles, or can be a skin mounted “tattoo” style device. Any description of component or attributes in connection with a “tattoo” style device herein is also applicable to an electronic device that is mounted to an article disposed proximate to the skin or an example electronic device that is coupled to the skin using one or more intermediate articles. Non-limiting examples of targets use cases and applications include user authentication, mobile payments, and location tracking (given with available RFID reader infrastructures). The platform can be configured to operate without a battery or other power source (a battery-less mode) and can be powered through NFC energy harvesting.

With skin adhesive and encapsulation, the “tattoo” style device can be worn on the skin for at least 5-7 days. The users are able to perform all the normal life activities while wearing the “tattoo”—i.e. taking showers, swimming, exercising and sweating. The example electronic device can be configured such that the “tattoo” is disposable and once it is removed from the skin it stops working

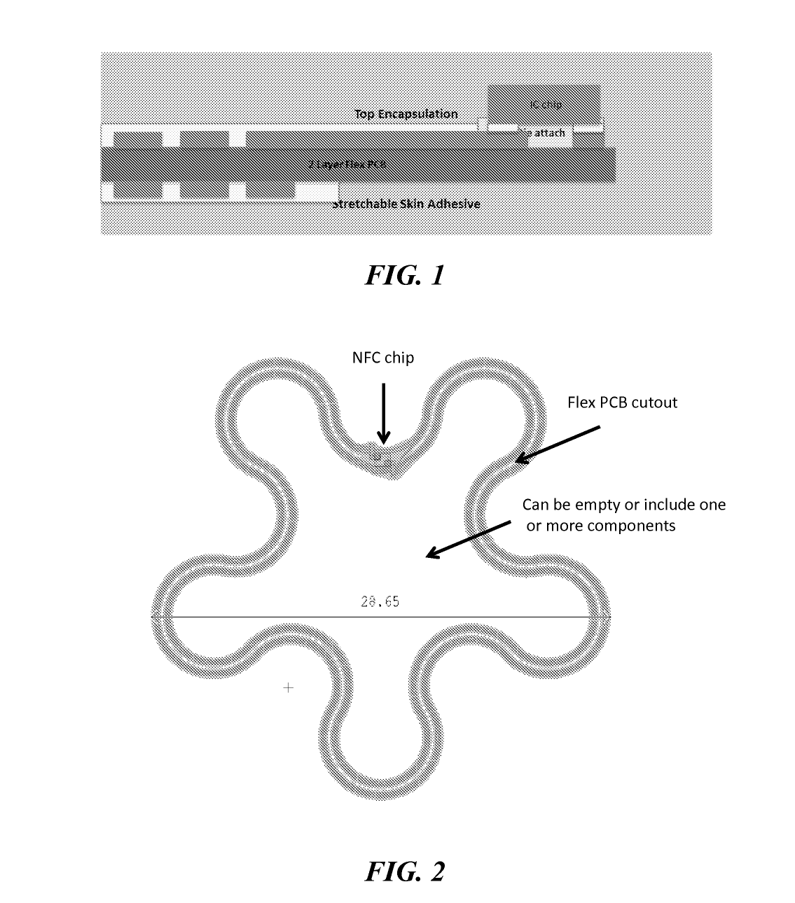

The example electronic device can be configured such that the “tattoo” product can take a form in a 3-layer structure. The middle layer (“inlay”) can be a 2 metal layer flex PCB with a bare die NFC chip attached. The top layer (away from the skin) can be an encapsulation layer that adds protection to the flex PCB and the die and serves as the base for optional graphic printing. In an example, the bottom layer can be a stretchable skin adhesive for an application touching the skin, such as but not limited to, skin wearing. FIG. 1 shows an example schematic of a 3-layer structure with the various components.

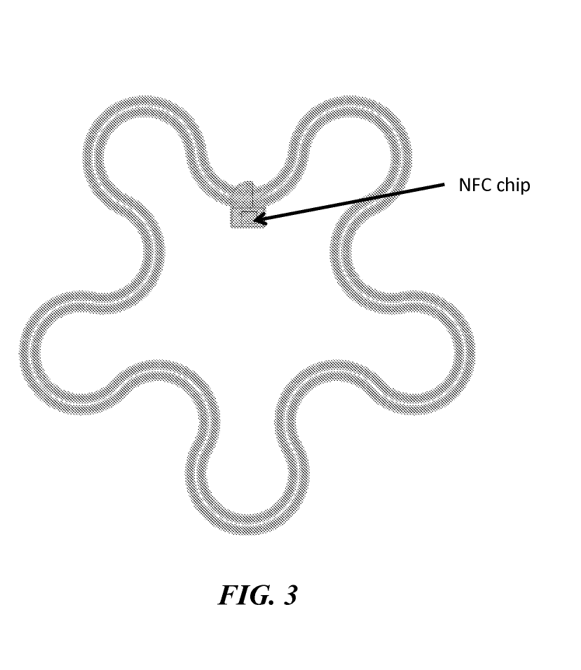

The example device can include a NFC/RFID antenna that spans much of the “tattoo” area. In an example implementation, with the current antenna design, the “tattoo” can be made a bit larger than about 1 inch in diameter. The example antenna can be built from a narrow cut out of the 2 metal layer flex PCB. In an example, the antenna can be configured to have as many as up to 6 or more turns and a flower like shape. FIGS. 2 and 3 show example antenna configurations. Other example antenna conformations and configurations are also applicable.

### Example Specifications

Table 1 shows the example specifications of an example electronic device.

TABLE 1
Example specifications

| | | |
|---|---|---|
| Example | Dimension | 25-35 mm in diameter, ~100 um |
| electronic | | average thickness for the skin |
| device | | mounted part |
| | Weight | TBD |
| | Power | Battery less |
| | Communication | NFC (13.56 MHZ) |
| | Operating Conditions | 0° C. to 40° C. 15%-95% RH |
| | Storage Conditions | −10° C. to 60° C. 15%-95% RH for |
| | | 2 years |
| | Moisture Exposure | TBD |
| | Certifications | TBD |

### Example Electronic Device Manufacturing Process Flow

An example process flow to produce an example electronic device is summarized in the process 400 flow block diagram in FIG. 4. It provides non-limiting example of process flows that can be implemented for high volume manufacturing with viable cost reduction avenues. The process 400 can be divided into to three processes, the flexible printed circuit board fabrication process, Flex PCB Fab 410, the die attachment process 420 and the converting process 430.

Flex PCB: the flex PCB fabrication process 410 can include the following steps. The flex PCB can be fabricated from a copper clad polyimide panel having a copper layer on each side in step 412. The copper clad polyimide panel can be pre-cut to the desired shape as shown in, for example, FIG. 3, 8A, or 9A or after die attachment. The vias (through holes providing electrical connections between opposite sides of the polyimide panel) can be formed by drilling (e.g., punching, mechanical or Laser drilling) holes in the polyimide and then plating and filling the holes with a conductive material in step 414. The copper traces can be formed by Laser direct write or photolithography in step 416 and etching away the unwanted copper in step 418. In some embodiments, the traces can be formed before the vias are formed. Examplary specifications and the design rules for the flex PCB are summarized in Table 2 with non-limiting example considerations included.

TABLE 2
Specifications and the design rules for the flex PCB

| | | Non-limiting Example |
|---|---|---|
| Item | Spec | Considerations. |
| Base material | 1 mil/25 um | Meet specified thickness |
| | | requirement, such as but not |
| | | limited to, being able to move to |
| | | ½ mil |
| Metal | Less than 0.5 mil | Meet specified thickness |
| | | requirement |
| Trace | 3 mil width and | Width/space can be slightly larger |
| | 2 mil space | or smaller |
| Via | 25 um/25 um | Width/space can be larger (up to |
| | size/space | about 100 um) |

Other flex PCB options such as, but not limited to, PET with copper, PET with etched aluminum, as well as PET with printed silver paste, can also be utilized. The specifications and the design rules can be modified to accommodate different configurations. The traces can be formed by an additive process that includes forming the traces on the polyimide or other base substrate.

In an example, there may be no copper finishes for the copper traces.

Die attach: The die can be attached according to any known process in step 420. In an example, anisotropic conductive paste (ACP) such as but not limited to Delo ACP265® (DELO Industrial Adhesives, Windach, Germany) or any other conductive paste (including heat-curing paste or other paste including NiAu particles), can be used for the die attach. The size of the die can be 0.505 mm×0.72 mm. In various examples, the die thickness can be 50 um+/−10 um and 120 um+/−15 um. Alternatively, the die can be attached using wire bonding or well-known flip chip processing.

Converting: The converting process 430 takes in the flex PCB with attached die and converts it into an electronic device (in this example, a tattoo structure) with one or two liners at the top and the bottom. The bottom surface of flex PCB with the die can be laminated to an adhesive layer or adhesive layer and a liner (e.g., for storage and to protect the adhesive layer prior to use) in step 432. The adhesive liner or the adhesive layer and the liner can be cut (e.g., by Laser or die) to a predefined shape at step 434. The top surface of the flex PCB can be laminated to top encapsulant layer in step 436. The top encapsulant layer can be preprinted with graphics and/or indicia prior lamination at step 440. Alternatively, the top encapsulant layer can be preprinted with graphics and/or indicia after lamination. The final device shape can be formed by the final cut (e.g., by Laser or die) to form the predefined (e.g., “tattoo” or) other shape. Where the device is fabricated in sheet form the individual devices can be kiss cut or perforated cut to enable the devices to be produced in sheets. A top liner or protective layer can also be applied to protect the top encapsulant layer and to facilitate handling.

Once the product is in this form, other final forms can be made either still in panels or in rolls with single row of tattoo (such as but not limited to, at end customers request). A non-limiting example skin adhesive that can be used with good results is FLEXCON DERMAFLEX™ H-566 1 mil thick with release liner (Flexcon Industries, Randolph, Mass.). In an example, the encapsulant can be a thermoplastic polyurethane (TPU) less than 1 mil thick. In any example, graphic printing (e.g., images, symbols, indicators and indicia) can be put on the TPU top encapsulant.

### Example Electronic Device Manufacturing Measurements

Non-limiting example measurements for verification of an example electronic device are as follows. Flex PCBs can be tested for open and short. At the initial stage of process flow development, the total resistance can be measured between pairs of terminal of traces, including for non-copper metal traces. Inductance measurements can also be performed. Both tests can be on a sampling base with a predetermined sampling rate. The die attach procedure can be performed according to a die map provided by a NFC die vendor.

After die attach, NFC functionality test can be performed on a sampling base—the sampling rate can be on the higher side initially. Once the die attach process yield is stabilized, the sampling rate can be lower accordingly. The NFC functionality test can be set up using a NFC/RFID reader that is based on reference designs provided by the NFC chip vendors. The functionality test can be a reading of the unique identification (UID) of each NFC chip. The distance (“working distance”) between the reader plane and the antenna/NFC chip plane can be varied, measured and recorded for the measurement.

A similar NFC functionality test can be performed during and/or after the converting process. The test set up can be the same as used for other measurements. Besides reading out the UID for each chip, certain customized writing to each chip can be used per custom specification. The writing step can be performed using the same reader. For both the reading and the writing steps, batch type process is possible by using readers with large area antennas.

### Example Electronic Device NFC/RFID Chip

In the example electronic device product, NXP NTAG 213 chips (NXP Semiconductors, San Jose, Calif.) that comply with ISO 14443 type A and NFC forum type 2 specifications can be used.

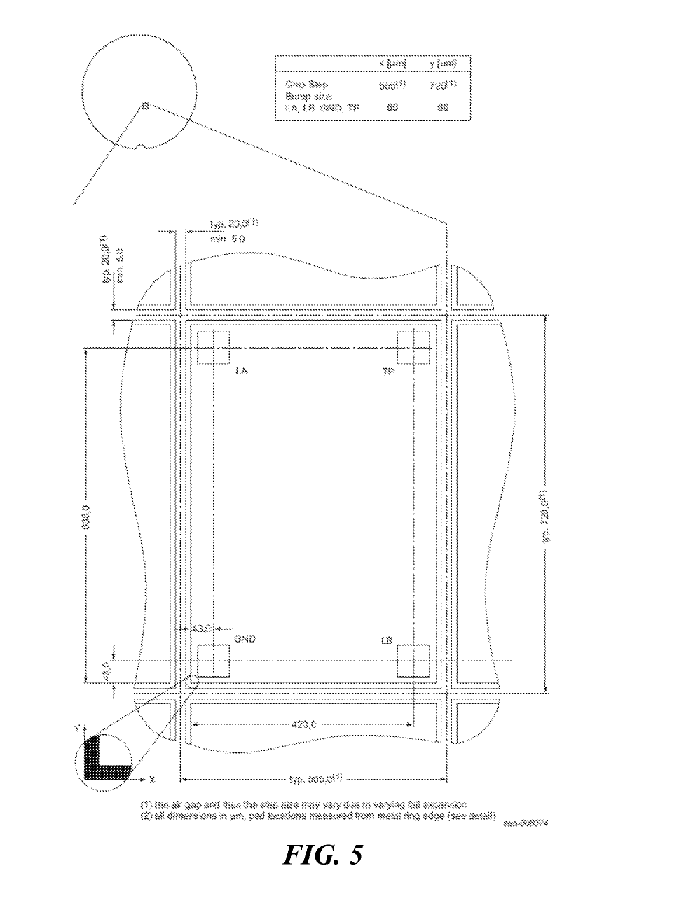

Bare dies are used in the example electronic device. FIG. 5 shows the NTAG™ 213 bare die outline, I/O pad locations on the die and the die dimensions. In this example, there are in total 4 I/Os on the die, and LA and LB I/Os are used to connect to the antenna in the example electronic device configuration. In addition, there is no polarity between LA and LB.

### Example Electronic Device Antenna Design

Two non-limiting example electronic device configurations with differing antenna designs are as follows. Both antenna designs are drawn to comply with the trace and via sizes. The example antenna designs can be fabricated based on drawing interchange format, or drawing exchange format (DXF) CAD files and/or Gerber (open 2D bi-level vector image format) files.

Non-limiting example antenna design A and B are shown in FIGS. 2 and 3 respectively. There are 6 turns of antenna traces in both designs. The 6 turns are divided into two groups and between the groups there is a slit (100 um) in the polyimide. Each group of traces sits on a narrow polyimide cutout of 620 um width. An overpass metal layer provides connection between the two ends of the antenna trace. The NFC die sits on metal landing pads that connect antenna traces to the two antenna I/Os (LA & LB) on the die.

The difference between design A and B is the die placement. In design A the die is placed towards the center of the flower shape antenna, whereas in design B the die placed between the two groups of antenna traces at the slit area. Many other electronic device configurations are also possible based on the principles described herein.

### Example Electronic Device Reliability Measurements

The reliability measurements for an example electronic device can be performed in two variations—one variation for storage/transportation where the “tattoo” has liners on both sides, and the other variation is for actual wear where both liners are removed and the “tattoo” is mounted to the skin (or other object coupled to the skin).

For the storage scenario, these following reliability parameters can be measured, the exact conditions can be modified:
High temperature storage: 120 C (tentative) for 1000 hours
Temperature humidity bias: 85 C and 95% relative humidity (RH) for 1000 hours
Humidity test: 25 C and 95% RH, time to fail
Thermal cycling: 0° C. to 100° C., 2 cycles/hour, test to fail
Thermal shock: −10° C. to 60° C., 15 cycles, 2 min dwell time and 10 sec transfer, test to fail
Shipping test: repetitive shock, bump and drop, compression, vibration
ESD and EMI

For the wear scenario, the following reliability parameters can be measured, the exact conditions can be modified:
Humidity test: 25° C. and 95% RH, time to fail
Temperature humidity bias: 85° C. and 95% RH for 1000 hours
Salt spray test
Water immersion test and water resistance test
Sunscreen, DEET (insect repellent), and moisturizing lotion resistance tests
Example electromechanical tests
Bending
Creasing
Stretching (uni-axial and bi-axial)

### Example 2

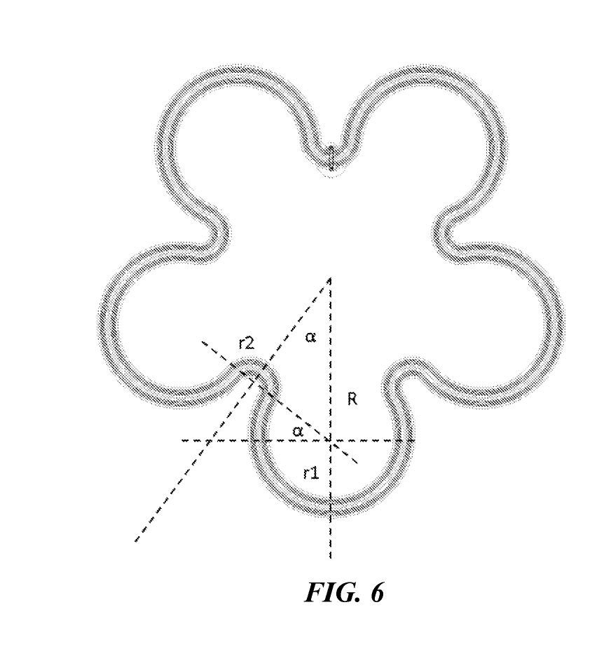

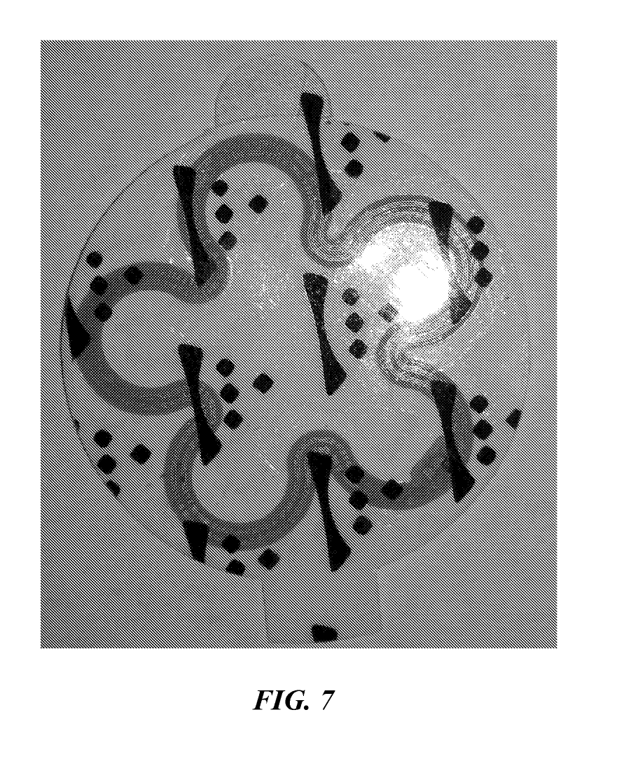

General design methodologies, considerations and rules are outlined and herein. The antenna design of FIG. 6 is used as an example to illustrate the design parameters with their expressions provided and explained.

Generally, these are the considerations and rules that can be followed for the design:
1. A standard electrical calculation and/or simulation can be performed to find out the number of turns and the diameter for a functional NFC RFID circular antenna.
2. Each antenna turn or a subset group of one or more antenna turns can be on its own singulated base substrate except for the part where one turn is connected with the next turn. For example, if there are in total 8 turns of antenna are used, these 8 turns can be on eight singulated base substrates, each of which is slightly wider than the turn. Or sub groups of 2 turns can be on their own singulated based substrates—so on and so forth.
3. Antenna turns should all be concentric to minimize the overall total width for the turns (on their base substrates). The whole loop of each turn can be divided into multiple segments of arcs with each segment of arc having its own radius. For example, arc segment AB, which spans an angle of α, can take a radius of R_AB whereas the next arc segment BC, which spans an angle of β, can take a different radius of R_BC. It is beneficial in terms of flexibility and stretchability to have radii much greater than the width of the base substrate (w) for the corresponding turn—that is R>>w.
4. The whole loops of antenna turns can be made up with multiple segments of arcs as described in the previous bullet. Each arc can have its arc center either outside the loop or inside the loop. For both cases the R>>w consideration is desirable.
5. In the case where all the arc segments have its arc center inside the loop, the sum of the angles each arc spans is preferably 360 degrees for simple geometry. In the case where the arcs have their center both inside and outside the loop, the rules are much more complicated.

The rules for the example shown in FIG. 6 is given below.

Antenna Design Layout Parameters: 2^{α}=360/n, where n is the number of petals; r1 and r2 are the radii for the outer arc and the inner arc that make the petals respectively; the inner arc is a half circle and the outer arc is a half circle plus two arcs on each side corresponding to an angle a; R is the radius for the circular following the outside of the petals, where R=r1+(r1+r2)/sin(α).

Antenna Trace Parameters: trace width (w1) and space (s1); slit (s2)—space left out as cut out slit between groups of traces; space left out on base material for die cutting the antenna out (s3); the total antenna cut out width (w) is: w=L*w1+(L−1)*s1+s2+2*s3, where L is the number of antenna coil turns.

Total Available Antenna Design Parameters: n: number of petals; r1 & r2: radii for petals; w1 & s1: trace width and space; t: trace/metal thickness; s2 & s3: space left out for die cutting; L: number of antenna coil turns.

Mechanical stress thresholds for each arc segment of the antenna turns can be engineered and controlled which permit the whole antenna loop (i.e. all the antenna turns and their base substrates) physically break upon a mechanical stress that is greater than the designed threshold value. In one example, this can be the scenario that the antenna loop breaks when it is being removed from the skin enabling a security feature.

At least one segment of arc can be designed with its R<=w to intentionally serve as the weak point which breaks at a certain stress value—the threshold. In example where R=w, the threshold stress is at S1 and in another example where R=1/2w, the threshold stress is at S2. Though there is no straightforward analytical solution outlining the stress threshold as a function of R/w. But people who are familiar with art should be able to extrapolate such curves for particular designs and material constructions. Multiple segments can be designed like this to ensure the antenna loop breaks at at least one segment at the threshold. Take the design in FIG. 6 as an example, all the arc segments whose radii are r2 are the weak points in design. And since all the antenna turns are concentric, as long as the outmost turn has segments where R/w is so that the segments break at a threshold, all the corresponding segments in the inner turns should all break as their radii are even less than R.

Materials can be used for the metal traces of the antenna turns include but not just limited to are copper, aluminum, silver, silver paste, paste with nano particles.

Materials can be used for the base substrates include but not just limited to are polyimide (PI), polyethylene terephthalate (PET), polyester (PE), polyurethane (PU), polycarbonate (PC).

Both the total number of antenna turns and the diameter for the whole loop can be determined by the desired antenna electrical performance, the trace width for each turn and hence the width for the corresponding base substrate (w) has an upper limit to accommodate those number of turns within the diameter. The trace thickness, on the other hand, can be relatively freely changed to tune the total AC resistance of the whole loop to achieve an optimal antenna quality factor (Q).

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be examples and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that inventive embodiments may be practiced otherwise than as specifically described. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention may be implemented in any of numerous ways, including through implementations provided in the description herewith. For example, some embodiments may be implemented using hardware, software or a combination thereof. When any aspect of an embodiment is implemented at least in part in software, the software code may be executed on any suitable processor or collection of processors, whether provided in a single device or computer or distributed among multiple devices/computers.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

What is claimed is:

1. A flexible antenna comprising
a base substrate; and
a first plurality of metal loops arranged in a concentric manner and disposed on a first side of the base substrate, wherein:
(i) the metal loops are electrically connected, whereby electrical connectivity is maintained during flexing; and
(ii) each metal loop comprises at least two arc segments, each arc segment having an arc center and a radius, wherein the radius of one arc segment is greater than the radius of at least one other arc segment.

2. The flexible antenna of claim 1, wherein the arc centers alternate between being inside the metal loop and outside the metal loop.

3. The flexible antenna of claim 1, wherein all the arc centers are inside the metal loop.

4. The flexible antenna of claim 1, wherein all the arc centers are outside the metal loop.

5. The flexible antenna of claim 1, wherein the antenna is substantially planar in a resting state.

6. The flexible antenna of claim 2, wherein the arc centers inside the metal loop are arranged in a geometric pattern.

7. The flexible antenna of claim 2, wherein the arc centers outside the metal loop are arranged in a geometric pattern.

8. The flexible antenna of claim 6, wherein the geometric pattern is rectangular, circular, elliptical, oval, octagonal, hexagonal, or pentagonal.

9. The flexible antenna of claim 7, wherein the geometric pattern is rectangular, circular, elliptical, oval, octagonal, hexagonal, or pentagonal.

10. The flexible antenna of claim 1, wherein a portion of the base substrate inside the metal loops is removed, thereby permitting the antenna to be stretchable.

11. The flexible antenna of claim 1, wherein the base substrate is physically separated into a plurality of singulated substrates, wherein at least one metal loop is disposed on each singulated substrate.

12. The flexible antenna of claim 1, wherein the base substrate has a thickness of no more than 100 μm.

13. The flexible antenna of claim 1, wherein each metal loop has a thickness of no more than 100 μm.

14. The flexible antenna of claim 1, wherein each arc segment of the metal loop has a radius greater than the width of the substrate having the metal loop disposed thereon.

15. The flexible antenna of claim 1, wherein the antenna conforms to a surface to which it is applied.

16. The flexible antenna of claim 1, wherein the antenna permits short-range wireless communication.

17. The flexible antenna of claim 16, wherein the short-range wireless communication is near field communication (NFC) or radio-frequency identification (RFID).

18. The flexible antenna of claim 1, wherein each metal loop is comprised of a metal selected from the group consisting of copper, aluminum, gold, platinum, silver, silver paste, and paste with metallic nanoparticles.

19. The flexible antenna of claim 1, wherein the base substrate is comprised of polyimide, polyethylene terephthalate, polyester, polyurethane, polycarbonate, or a combination thereof.

20. The flexible antenna of claim 1, further comprising a second plurality of metal loops arranged in a concentric manner and disposed on a second side of the base substrate, wherein the second plurality of metal loops are electrically connected to the first plurality of metal loops.

21. The flexible antenna of claim 1, further comprising an encapsulation layer and an adhesive layer, wherein the base substrate and the first plurality of metal loops are sandwiched between the encapsulation layer and the adhesive layer.

22. The flexible antenna of claim 21, wherein the encapsulation layer and/or the adhesive layer is gas permeable.

23. The flexible antenna of claim 1, further comprising an encapsulation layer, wherein the encapsulation layer embeds the base substrate and the first plurality of metal loops, whereby flexing the encapsulation layer flexes the antenna.

24. The flexible antenna of claim 1, further comprising at least one mechanical stress weak point that can break when a certain mechanical stress threshold is reached.

25. The flexible antenna of claim 2, wherein each metal loop comprises 5 arc segments having arc centers inside the metal loop, and 5 arc segments having arc centers outside the metal loop.

26. A flexible device for short-range wireless communication comprising
(a) an antenna comprising:
a base substrate; and
a first plurality of metal loops arranged in a concentric manner and disposed on the first side of the base substrate, wherein:
(i) the metal loops are electrically connected, whereby electrical connectivity is maintained during flexing; and
(ii) each metal loop comprises at least two arc segments, each arc segment having an arc center and a radius, wherein the radius of one arc segment is greater than the radius of at least one other arc segment;
and
(b) a chip or an integrated circuit electrically connected to the antenna.

27. The flexible device of claim 26, wherein the short-range wireless communication is near field communication (NFC).

28. The flexible device of claim 26, wherein the arc centers alternate between being inside the metal loop and outside the metal loop.

29. The flexible device of claim 26, wherein all the arc centers are inside the metal loop.

30. The flexible device of claim 26, wherein all the arc centers are outside the metal loop.

31. The flexible device of claim 26, wherein the device is substantially planar in a resting state.

32. The flexible device of claim 28, wherein the arc centers inside the metal loop are arranged in a geometric pattern.

33. The flexible device of claim 28, wherein the arc centers outside the metal loop are arranged in a geometric pattern.

34. The flexible device of claim 32, wherein the geometric pattern is rectangular, circular, elliptical, oval, octagonal, hexagonal, or pentagonal.

35. The flexible device of claim 33, wherein the geometric pattern is rectangular, circular, elliptical, oval, octagonal, hexagonal, or pentagonal.

36. The flexible device of claim 26, wherein a portion of the base substrate inside the metal loops is removed, thereby permitting the antenna to be stretchable.

37. The flexible device of claim 26, wherein the base substrate is physically separated into a plurality of singulated substrates, wherein at least one metal loop is disposed on each singulated substrate.

38. The flexible device of claim 26, wherein the base substrate has a thickness of no more than 100 μm.

39. The flexible device of claim 26, wherein each metal loop has a thickness of no more than 100 μm.

40. The flexible device of claim 26, wherein each arc segment of the metal loop has a radius greater than the width of the substrate having the metal loop disposed thereon.

41. The flexible device of claim 26, wherein the device conforms to a surface to which it is applied.

42. The flexible device of claim 26, wherein each metal loop is comprised of a metal selected from the group consisting of copper, aluminum, gold, platinum, silver, silver paste, and paste with metallic nanoparticles.

43. The flexible device of claim 26, wherein the base substrate is comprised of polyimide, polyethylene terephthalate, polyester, polyurethane, polycarbonate, or a combination thereof.

44. The flexible device of claim 26, wherein the antenna further comprises a second plurality of metal loops arranged in a concentric manner and disposed on a second side of the base substrate, wherein the second plurality of metal loops are electrically connected to the first plurality of metal loops.

45. The flexible device of claim 26, further comprising an encapsulation layer and an adhesive layer, wherein the antenna and the chip or integrated circuit are sandwiched between the encapsulation layer and the adhesive layer.

46. The flexible device of claim 45, wherein the encapsulation layer and/or the adhesive layer is gas permeable.

47. The flexible device of claim 26, further comprising an encapsulation layer, wherein the encapsulation layer embeds the antenna and the chip or integrated circuit, whereby flexing the encapsulation layer flexes the device.

48. The flexible device of claim 26, wherein the antenna further comprises at least one mechanical stress weak point that can break when a certain mechanical stress threshold is reached.

49. The flexible device of claim 28, wherein each metal loop comprises 5 arc segments having arc centers inside the metal loop, and 5 arc segments having arc centers outside the metal loop.
